(19) United States
(12) Patent Application Publication
(10) Pub. No.: US 2024/0367513 A1
(43) Pub. Date: Nov. 7, 2024

(54) INTEGRATED IMPAIRED DRIVING PREVENTION SYSTEM AND METHODS RELATING TO THE SAME

(71) Applicant: Chancellor Winston Hemphill, Wilmington, DE (US)

(72) Inventor: Chancellor Winston Hemphill, Wilmington, DE (US)

(21) Appl. No.: 18/654,721

(22) Filed: May 3, 2024

Related U.S. Application Data
(60) Provisional application No. 63/464,026, filed on May 4, 2023.

(51) Int. Cl. B60K 28/06; B60W 40/08; B60W 50/14

(52) U.S. Cl. CPC B60K 28/063; B60W 40/08; B60W 50/14; B60W 2050/146; B60W 2540/24

(57) ABSTRACT

Systems and methods for preventing operation of a vehicle, comprising an onboard operating system comprising instructions stored in a memory, which when executed by one or more processors causes the onboard operating system to receive information from at least one detection device configured to test for the presence of an impairment in a vehicle operator or driver; perform an analysis of the amount or degree or level of impairment of the vehicle operator or driver; display the amount, degree or level of impairment to the vehicle operator or driver via an onboard interface; and enable or disable operation and/or drivability of the vehicle based on the amount, degree or level of impairment of the vehicle operator or driver.

### REFERENCED APPLICATION

This patent application claims the benefit of U.S. Provisional Patent Application Ser. No. 63/464,026 filed on May 4, 2023 and entitled “Integrated Vehicle interlock system and Methods Relating to the Same”, the disclosure of which is hereby incorporated fully by reference herein in its entirety and made part of the present U.S. utility patent application for all purposes.

### TECHNICAL FIELD

The present disclosure relates generally to driving prevention systems for impaired drivers and methods of using the same, and more specifically to vehicle interlock systems integrated with and/or into a vehicle (e.g., car, truck, construction vehicles, bus, off-road vehicle, golf cart, boat, train, subway train, plane, helicopter, motorcycle, motor bike, scooter, electric motor bikes, go kart, jet ski, etc.—electric and/or gasoline/diesel powered) that determines or assists in determining whether a vehicle operator or driver is legally and/or physically able to operate the vehicle based on detected use of alcohol, drug and/or or other type of substance and/or some other physical aspect of the vehicle operator or driver. Although the present disclosure is specifically directed to vehicles and will be specifically described with reference thereto, it will be appreciated that the concepts associated with the present disclosure have broader applications and can be used in association with the operation of machinery, operation of cranes, operation of bridges, operation of train or subway rail lines, duties of an air traffic controller, and the operation of other devices that could result in damage or property or individuals if not operated properly as a result of an impaired operator.

### BACKGROUND OF DISCLOSURE

Conventional vehicle interlock systems are typically retrofitted devices that connect directly between a vehicle's starter and ignition system and typically use aftermarket components to deactivate the starting circuit of the vehicle if an input sensor such as breathe analyzer detects that a user's blood alcohol content (“BAC”) in excess of a predetermined limit. These vehicle interlock systems can be installed in existing motor vehicles, for example, persons convicted of a DUI offense, etc., as a means of allowing the offender to use their vehicle in limited circumstances.

Such conventional vehicle interlock systems typically include two components: a mouthpiece and a solenoid or switch. The mouthpiece is used for breath test and typically incorporates a screen to display data and one or more buttons to navigate and control the vehicle interlock system. The solenoid or switch interrupts an electrical circuit to either the starter or the ignition module of the vehicle when the user's blood alcohol content (“BAC”) in excess of a predetermined limit. Some of these vehicle interlock systems may be used with auto shut-off features of later model vehicles. Generally, the conventional vehicle interlock systems only test for the user's BAC, thus a drug impair user can circumvent conventional vehicle interlock systems.

In view of the current state of the art, there is a need for impaired driving/operating prevention and vehicle interlock systems and methods that utilize a vehicle's onboard operating systems to allow for broader testing capabilities and more effective and efficient testing to promote responsible vehicle operation.

### SUMMARY OF DISCLOSURE

The present disclosure is directed to an vehicle interlock system that can be integrated with and/or incorporated in a vehicle (e.g., car, truck, construction vehicles, bus, off-road vehicle, golf cart, boat, train, subway train, plane, helicopter, motorcycle, motor bike, scooter, electric motor bikes, go kart, jet ski, etc.—electric and/or gasoline/diesel powered). The vehicle interlock system is configured to determine or assist in determining whether a vehicle operator or driver is legally and/or physically able to operate the vehicle based on detected use of alcohol, drug and/or or other type of substance in the vehicle operator or driver and/or some other physical aspect of the vehicle operator or driver. In one non-limiting embodiment, the vehicle interlock system is integrated into and/or utilizes a vehicles onboard computer systems to determine or to assist in determining whether a vehicle operator or driver is legally and/or physically able to operate (e.g., drive the vehicle, operate one or more functions of the vehicle, etc.) the vehicle based on detected use of alcohol, drug and/or or other type of substance in the vehicle operator or driver and/or some other physical aspect of the vehicle operator or driver, and if the vehicle interlock system determines that the vehicle operator or driver is not legally and/or physically able to operate the vehicle, the vehicle interlock system inhibits or prevents the vehicle operator or driver from driving the vehicle.

In one non-limiting aspect of the present disclosure, there is provided an impaired driving prevention system that includes an onboard operating system that optionally includes instructions (e.g., software, set points, data, etc.) stored in a memory, which when executed by one or more processors causes the onboard operating system of a vehicle to receive information from at least one detection device that is configured to test for the presence of a predetermined substance in a vehicle operator or driver and/or to test some other physical aspect of the vehicle operator or driver. The information that is received from that at least one detection device can include, but is not limited to a) identification of a predetermined substance (e.g., alcohol, drugs, etc.) on and/or in a vehicle operator or driver, and/or b) identify a physically characteristic of a vehicle operator or driver that relates to potential impairment of the vehicle operator or driver (e.g., dilation level of pupils, drowsiness, seizure, abnormal blood pressure, body temperature, erratic behavior, etc.). The information that is received from the at least one detection device can be sent to one or more processors (e.g., one or more processor in the vehicle, one or more processors that are separate from the vehicle, one or more processors in a smart device, cell phone, computer, tablet and the like, etc.) to be analyzed to determine an amount, degree or level of impairment of the vehicle operator or driver. The impaired driving prevention system can then use such information from the at least one detection device to a) allow the vehicle operator or driver to operate and/or drive the vehicle, or b) prevent or inhibit the vehicle operator or driver from operating one or more functions of the vehicle and/or driving the vehicle. The at least one detection device can optionally be configured to a) produce a reading as to the an amount, degree or level of impairment (e.g., produce a reading as to blood alcohol content of the vehicle operator or driver, produce a reading as to drug levels of the vehicle operator or driver, produce a reading as to blood oxygen level of the vehicle operator or driver, produce a reading as to body temperature of the vehicle operator or driver, produce a reading as to pupil dilation of the vehicle operator or driver, etc.), and wherein such reading is sent to one or more processors (e.g., one or more processor in the vehicle, one or more processors that are separate from the vehicle, one or more processors in a smart device, cell phone, computer, tablet and the like, etc.) to be analyzed to determine an amount, degree or level of impairment of the vehicle operator or driver; b) enable a vehicle operator or driver to perform a drug and/or alcohol test, and/or some other physical test (e.g., blood pressure test, pupil dilation test, focus test, body temperature test, etc.); c) perform an analysis of i) the amount of the predetermined substance on and/or in the vehicle operator or driver to determine an amount, degree or level of impairment of the vehicle operator or driver, and/or ii) some other physical test of the vehicle operator or driver (e.g., level of drowsiness, attention span, blood pressure, level of pupil dilation, body temperature, etc.) to determine a level of impairment of the vehicle operator or driver; d) display the amount, degree or level of impairment to the vehicle operator or driver via an onboard interface; and/or e) enable or disable operation and/or drivability of the vehicle (e.g., lock steering wheel, engage parking brake, disengage ignition system, block fuel line to motor, disengage electric current to motor, disengage one more operations of the vehicle, prevent the movement and/or driving of the vehicle, etc.) based on the amount, degree or level of impairment of the vehicle operator or driver. As can be appreciated, one or more other components of the impaired driving prevention system can perform one or more of the above listed functions instead of or in addition to the at least one detection device.

In another and/or alternative non-limiting aspect of the present disclosure, the instructions stored in the memory of the impaired driving prevention system can optionally be configured to further cause the onboard operating system to determine that the test for the presence of the predetermined substance and/or some other physical test of the vehicle operator or driver is mandatory. In another and/or alternative non-limiting aspect of the present disclosure, the instructions stored in the memory of the impaired driving prevention system can be configured to cause the onboard operating system to determine that the test for the presence of the predetermined substance and/or some other physical test of the vehicle operator or driver is optional.

In another and/or alternative non-limiting aspect of the present disclosure, the instructions stored in the memory of the impaired driving prevention system can optionally be configured to further cause the onboard operating system to a) receive safety data of the vehicle operator or driver from one or more location sensors positioned in the vehicle and, in response, enable or disable operation and/or drivability of the vehicle based on whether the vehicle operator or driver is located in an operating seat of the vehicle; b) receive safety data from one or more window sensors and/or sunroof sensors and/or hatch window sensors and/or hatch sensors positioned in the vehicle and, in response, enable or disable operation and/or drivability of the vehicle based on whether the vehicle's windows, sunroof, hatch window and/or hatch are closed; c) receive safety data from one or more door sensors positioned in the vehicle and, in response, enable or disable operation and/or drivability of the vehicle based on whether the vehicle's doors are closed and/or locked; d) receive safety data from one or more seatbelt sensors and/or seat sensors positioned in the vehicle and, in response, enable or disable operation and/or drivability of the vehicle based on whether the vehicle operator or driver is properly seated in the seat and/or the seat belt is fastened, and/or whether the detected weight on the seat matches or closely matches the weight of the vehicle operator or driver so as to verify that only one person is on the seat and/or the proper person is on the seat; e) receive safety data from one or more sensors (e.g., motion sensor, camera, sound sensor, seat sensors, weight sensors, heat sensors, etc.) positioned in the vehicle and, in response, enable or disable operation and/or drivability of the vehicle based on whether there are other individuals and/or animals (e.g., pets, etc.) in the vehicle prior to and/or at the time the vehicle operator or driver is to be tested; and/or f) receive safety data from one or more sensors positioned in the vehicle (e.g., camera, eye scanner, fingerprint scanner, voice verification or recognition sensor, image scanner, etc.) vehicle and, in response, enable or disable operation and/or drivability of the vehicle based on whether the identity of vehicle operator or driver can be verified prior to and/or at the time the vehicle operator or driver is to be tested. This safety data can be used to a) ensure a proper testing environment of the vehicle operator or driver during testing of the vehicle operator or driver, and/or b) ensure that the vehicle operator or driver is the proper individual being tested.

In another and/or alternative non-limiting aspect of the present disclosure, the instructions stored in the memory of the impaired driving prevention system can optionally be configured to further cause the onboard operating system to display a warning to the vehicle operator or driver via the onboard interface and/or some other display (e.g., smart device, smart phone, tablet, display in vehicle, etc.) based on the amount, degree or level of impairment, and/or whether one or more preconditions have or have not been met (e.g., vehicle operator or driver is located in an operating seat of the vehicle, one or more of the vehicle's windows, sunroof, hatch window and/or hatch are open or closed, one or more vehicle doors are open or closed or locked, seatbelt is fastened or unfastened, etc.).

In another and/or alternative non-limiting aspect of the present disclosure, the instructions stored in the memory of the impaired driving prevention system can optionally be configured to further cause the onboard operating system to determine the information received from the at least one detection device is unreadable, and in response to determining that the information received from the at least one detection device is unreadable, prompt the vehicle operator or driver via the onboard interface to repeat the test for the presence of the predetermined substance and/or some other physical test of the vehicle operator or driver immediately or after a predetermined amount of time (e.g., within 1 seconds to 5 minutes and all values and ranges therebetween). If the repeated test is not passed within a certain period of time or by a certain number of tests, the impaired driving prevention system can be configured to disable operation and/or drivability of the vehicle for a certain period of time (e.g., 30 minutes to 1 week and all values and ranges therebetween), and/or be configured to allow operation of the vehicle and/or further testing of the impaired driving prevention system after entry (manual entry, voice command entry, etc.) and/or receipt (e.g., wireless transmission of code via cloud, cell tower, Bluetooth, smart device, cell phone, etc.) of an authorization code by an authorized user.

In another and/or alternative non-limiting aspect of the present disclosure, the instructions stored in the memory of the impaired driving prevention system can optionally be configured to further cause the onboard operating system to a) permit the vehicle operator or driver to enable operation of the vehicle after the vehicle operator or driver successfully passes the test for the presence of the predetermined substance and/or some other physical test of the vehicle operator or driver; and/or b) contact and/or send information to emergency personnel, police, fire department, department of public safety, etc. regarding the vehicle's location (e.g., GPS data of the vehicle that is stored in the onboard operating system, and/or obtained by a GPS sensor, cell tower location data that is stored in the onboard operating system, and/or obtained by a mobile data transmitter/sensor, etc.) when the vehicle operator or driver fails to pass the test for the presence of the predetermined substance and/or some other physical test of the vehicle operator or driver. The impaired driving prevention system can optionally be configured to further cause the onboard operating system to send information about the type of impairment of the vehicle operator or driver to emergency personnel, police, fire department, department of public safety, etc. regarding the vehicle's location when the vehicle operator or driver fails to pass the test for the presence of the predetermined substance and/or some other physical test of the vehicle operator or driver. As can be appreciated, for some vehicles and/or for some vehicle operators or drivers, the impaired driving prevention system can optionally be configured to always cause the onboard operating system to send information about the existence or non-existence of an impairment of the vehicle operator or driver to emergency personnel, police, fire department, department of public safety, a parent, guardian, court official, parole officer, vehicle owner, vehicle insurance company, mortgage company or bank or other lender that owns a mortgage or lien on vehicle, vehicle lessee, vehicle lessor, or combinations thereof regarding the vehicle's location when the vehicle operator or driver takes or completes a test for the presence of the predetermined substance and/or some other physical test of the vehicle operator or driver. The impaired driving prevention system can optionally be configured to allow an impaired vehicle operator or driver to a) start the vehicle, but not drive the vehicle, b) use a vehicle phone to call and/or request assistance and/or report an emergency or medical issue, etc., c) use a vehicle emergency call system to call and/or request assistance and/or report an emergency or medical issue, etc., d) plug in power devices to energize devices (e.g., charge cell phone, operate electric tire pump, operate a light, etc.), and/or e) allow the vehicle operator or driver to retake a test for the presence of the predetermined substance and/or some other physical test of the vehicle operator or driver when the vehicle operator or driver failed a prior test or the prior test results were not accepted. The impaired driving prevention system can optionally be configured to send GPS or other types of vehicle location information to a public safety agency, police, hospital, fire department, ambulance service, towing service, parent, guardian, court official, parole officer, vehicle owner, vehicle insurance company, mortgage company or bank or other lender that owns a mortgage or lien on vehicle, vehicle lessee, vehicle lessor, etc., when the impaired driving prevention system makes a determination that the vehicle operator or driver is impaired.

In another and/or alternative non-limiting aspect of the present disclosure, the instructions stored in the memory of the impaired driving prevention system can optionally be configured to further cause the onboard operating system to, via the onboard interface, via a remote transmitter, via cell tower signals, etc., receive one or more restrictions set by an authorized user, wherein the one or more restrictions include, but are not limited to, a) a minimum amount, degree or level of impairment of the vehicle operator or driver for a predetermined substance, b) maximum and/or minimum blood pressure, maximum amount of pupil dilation, maximum and/or minimum body temperature, etc.), and wherein the authorized user includes, but is not limited to, a parent, guardian, court official, parole officer, vehicle owner, vehicle insurance company, mortgage company or bank or other lender that owns a mortgage or lien on vehicle, vehicle lessee, vehicle lessor, or combinations thereof. The one or more restrictions can be used to disable operation and/or drivability of the vehicle. In another and/or alternative non-limiting aspect of the present disclosure, the authorized user can enter a passcode via the onboard interface, via a remote transmitter, via cell tower signals, etc. to lock or unlock or activate or deactivate one or more restrictions into the onboard operating system.

In another and/or alternative non-limiting aspect of the present disclosure, the impaired driving prevention system can optionally further include a storage and/or charging unit that is configured to store and/or charge the at least one detection device when not in use by the vehicle operator or driver, and wherein the storage and charging unit is optionally partially or fully integrated into the vehicle's steering wheel, seat, ceiling, visor, dashboard, and/or door.

In another and/or alternative non-limiting aspect of the present disclosure, the predetermined substance is an illegal drug, marihuana, alcohol, cannabidiol (cbd), tetrahydrocannabinol (THC), a stimulant, a pain medication, a depressant, a hallucinogen, a psychoactive drug or substance, an over-the-counter medication, or combinations thereof.

In another and/or alternative non-limiting aspect of the present disclosure, the instructions stored in the memory of the impaired driving prevention system can optionally be loaded and/or installed on the memory of the onboard operating system during vehicle manufacturing and/or vehicle servicing.

In another and/or alternative non-limiting aspect of the present disclosure, the at least one detection device can optionally be a breathalyzer, transdermal test, eye scan tester, blood tester, blood pressure tester, body temperature tester, passive breath testing device, or combinations thereof. As can be appreciated, other or additional detection devices can be used to detect whether a vehicle operator or driver has one or more impairment that should prevent the vehicle operator or driver from driving a vehicle.

In another and/or alternative non-limiting aspect of the present disclosure, the onboard interface of the impaired driving prevention system can optionally be a touch-screen interface, and wherein the onboard interface is optionally a portion of dashboard display, a center counsel display, an infotainment display, and/or a heads-up display of the vehicle. The one or more displays may or may not be a touch-screen display. When one or more of the displays is a touch-screen display, the touch-screen display can be used by the vehicle operator or driver and/or some other person to operate, navigate, activate, operate control and/or display one or more features, components and/or functions of the impaired driving prevention system. The one or more touch-screen displays can be an OEM display in the vehicle or be a retrofitted display in the vehicle.

In another and/or alternative non-limiting aspect of the present disclosure, there is provided a method to inhibit or prevent impaired operation of a vehicle that includes a) using an onboard operating system to inhibit or prevent impaired operation of a vehicle, wherein the onboard operating system includes one or more processors that include instructions stored in a memory; b) the one or more processors receive information from at least one detection device that is configured to test for the presence of a predetermined substance in an individual and/or perform some other physical test of the vehicle operator or driver; c) the one or more processors perform an analysis of the amount of the predetermined substance and/or an analysis of other physical test of the vehicle operator or driver to determine an amount, degree or level of impairment of the vehicle operator or driver, d) the one or more processors optionally cause a display device (e.g., via an onboard interface, LCD display, mobile device, smart phone, tablet, etc.) to display the amount, degree or level of impairment to the vehicle operator or driver, and e) the one or more processors cause the disablement of the operation of the vehicle and/or allow the operation of the vehicle based on the amount, degree or level of impairment of the vehicle operator or driver.

In another and/or alternative non-limiting aspect of the present disclosure, the method optionally further comprises receiving safety data to a) ensure a proper testing environment of the vehicle operator or driver during testing of the vehicle operator or driver, and/or b) ensure that the vehicle operator or driver is the proper individual being tested. In one non-limiting embodiment, the method optionally comprises receiving safety data of the vehicle operator or driver in the vehicle from one or more location sensors positioned in the vehicle and, in response to the information obtained by the one or more location sensors, enabling or disabling operation of the vehicle based on whether the vehicle operator or driver is located in an operating seat of the vehicle. In another non-limiting embodiment, the method optionally further comprises receiving safety data from one or more window sensors and/or sunroof sensors and/or hatch window sensors and/or hatch sensors positioned in the vehicle and, in response, enable or disable operation and/or drivability of the vehicle based on whether the vehicle's windows, sunroof, hatch window and/or hatch are closed. In another non-limiting embodiment, the method optionally further comprises receiving safety data from one or more door sensors positioned in the vehicle and, in response, enable or disable operation and/or drivability of the vehicle based on whether the vehicle's doors are closed and/or locked. In another non-limiting embodiment, the method optionally further comprises receiving safety data from one or more seatbelt sensors and/or seat sensors positioned in the vehicle and, in response, enable or disable operation and/or drivability of the vehicle based on whether the vehicle operator or driver is properly seated in the seat and/or the seat belt is fastened, and/or whether the detected weight on the seat matches or closely matches the weight of the vehicle operator or driver so as to verify that only one person is on the seat and/or the proper person is on the seat. In another non-limiting embodiment, the method optionally further comprises receiving safety data from one or more sensors (e.g., motion sensor, camera, sound sensor, seat sensors, weight sensors, heat sensors, etc.) positioned in the vehicle and, in response, enable or disable operation and/or drivability of the vehicle based on whether there are other individuals and/or animals (e.g., pets, etc.) in the vehicle prior to and/or at the time the vehicle operator or driver is to be tested. In another non-limiting embodiment, the method optionally further comprises receiving safety data from one or more sensors positioned in the vehicle (e.g., camera, eye scanner, fingerprint scanner, voice verification or recognition sensor, image scanner, etc.) vehicle and, in response, enable or disable operation and/or drivability of the vehicle based on whether the identity of vehicle operator or driver can be verified prior to and/or at the time the vehicle operator or driver is to be tested.

In another and/or alternative non-limiting aspect of the present disclosure, the method further optionally comprises determining whether the information received from the at least one detection device is unreadable, and in response to determining that the information received from the at least one detection device is unreadable, prompting the vehicle operator or driver via the onboard interface, display, mobile device, smart phone, tablet. etc. to repeat the test for the presence of the predetermined substance and/or some other physical test of the vehicle operator or driver immediately or after a predetermined amount of time (e.g., within 1 seconds to 5 minutes and all values and ranges therebetween). If the repeated test is passed, the impaired driving prevention system can be configured to allow the vehicle operator or driver to operate the vehicle. The impaired driving prevention system can optionally be configured to allow a user to repeat the test in a certain number of times (e.g., repeat testing 1-5 times and all values and ranges therebetween) within a certain period of time (e.g., 1 second to 5 minutes and all values and ranges therebetween). If the repeated test is not passed within a certain period of time or by a certain number of tests, the impaired driving prevention system can be configured to disable operation and/or drivability of the vehicle for a certain period of time (e.g., 30 minutes to 1 week and all values and ranges therebetween), and/or be configured to allow operation of the vehicle and/or further testing of the impaired driving prevention system after entry (manual entry, voice command entry, etc.) and/or receipt (e.g., wireless transmission of code via cloud, cell tower, Bluetooth, smart device, cell phone, etc.) of an authorization code by an authorized user.

In another and/or alternative non-limiting aspect of the present disclosure, the method further optionally comprises causing the onboard operating system to a) permit the vehicle operator or driver to enable operation of the vehicle after the vehicle operator or driver successfully passes the test for the presence of the predetermined substance and/or some other physical test of the vehicle operator or driver; and/or b) contact and/or send information to emergency personnel, police, fire department, department of public safety, etc. regarding the vehicle's location (e.g., GPS data of the vehicle that is stored in the onboard operating system, and/or obtained by a GPS sensor, cell tower location data that is stored in the onboard operating system, and/or obtained by a mobile data transmitter/sensor, etc.) when the vehicle operator or driver fails to pass the test for the presence of the predetermined substance and/or some other physical test of the vehicle operator or driver, and c) optionally send information about the type of impairment of the vehicle operator or driver to emergency personnel, police, fire department, department of public safety, etc. regarding the vehicle's location when the vehicle operator or driver fails to pass the test for the presence of the predetermined substance and/or some other physical test of the vehicle operator or driver.

In another and/or alternative non-limiting aspect of the present disclosure, the method optionally further comprises receiving one or more restrictions set by an authorized user, wherein the one or more restrictions include, but are not limited to, a) a minimum amount, degree or level of impairment of the vehicle operator or driver for a predetermined substance, b) maximum and/or minimum blood pressure, maximum amount of pupil dilation, maximum and/or minimum body temperature, etc.), and wherein the authorized user includes, but is not limited to, a parent, guardian, court official, parole officer, vehicle owner, vehicle insurance company, mortgage company or bank or other lender that owns a mortgage or lien on vehicle, vehicle lessee, vehicle lessor, or combinations thereof. The one or more restrictions can be used to disable operation and/or drivability of the vehicle. In another and/or alternative non-limiting aspect of the present disclosure, the authorized user can enter a passcode via the onboard interface, via a remote transmitter, via cell tower signals, etc. to lock or unlock or activate or deactivate one or more restrictions into the onboard operating system.

One non-limiting object of the disclosure is the provision of an impaired driving prevention system to inhibit or prevent the operation of a vehicle by an impaired vehicle operator or driver.

Another and/or alternative object of the disclosure is the provision of impaired driving prevention system that includes an vehicle interlock systems that are integrated with and/or into a vehicle that determines or assists in determining whether a vehicle operator or driver is legally and/or physically able to operate the vehicle based on detected use of alcohol, drug and/or or other type of substance, and/or other types of physical aspect of the vehicle operator or driver.

Another and/or alternative object of the disclosure is the provision of impaired driving prevention system that includes (a) an onboard operating system comprising instructions stored in a memory, which when executed by one or more processors causes the onboard operating system of a vehicle to (i) receive information from at least one detection device configured to test for the presence of a predetermined substance in an individual, and/or other type of physical aspect of the vehicle operator or driver; (ii) perform an analysis of the amount of the predetermined substance and/or an analysis of other types of physical aspects of the vehicle operator or driver to determine an amount, degree or level of impairment of the individual; (iii) optionally display the amount, degree or level of impairment to the individual via an onboard interface; and (iv) enable or disable operation and/or drivability of the vehicle based on the amount, degree or level of impairment of the individual.

Another and/or alternative object of the disclosure is the provision of impaired driving prevention system wherein the instructions stored in the memory further causes the onboard operating system to determine that the test for the presence of the predetermined substance and/or test for another type of physical aspect of the vehicle operator or driver is mandatory or optional.

Another and/or alternative object of the disclosure is the provision of impaired driving prevention system wherein the instructions stored in the memory further cause the onboard operating system to: a) receive safety data of the vehicle operator or driver from one or more location sensors positioned in the vehicle and, in response, enable or disable operation and/or drivability of the vehicle based on whether the vehicle operator or driver is located in an operating seat of the vehicle; b) receive safety data from one or more window sensors and/or sunroof sensors and/or hatch window sensors and/or hatch sensors positioned in the vehicle and, in response, enable or disable operation and/or drivability of the vehicle based on whether the vehicle's windows, sunroof, hatch window and/or hatch are closed; c) receive safety data from one or more door sensors positioned in the vehicle and, in response, enable or disable operation and/or drivability of the vehicle based on whether the vehicle's doors are closed and/or locked; d receive safety data from one or more seatbelt sensors and/or seat sensors positioned in the vehicle and, in response, enable or disable operation and/or drivability of the vehicle based on whether the vehicle operator or driver is properly seated in the seat and/or the seat belt is fastened, and/or whether the detected weight on the seat matches or closely matches the weight of the vehicle operator or driver so as to verify that only one person is on the seat and/or the proper person is on the seat; e) receive safety data from one or more sensors (e.g., motion sensor, camera, sound sensor, seat sensors, weight sensors, heat sensors, etc.) positioned in the vehicle and, in response, enable or disable operation and/or drivability of the vehicle based on whether there are other individuals and/or animals (e.g., pets, etc.) in the vehicle prior to and/or at the time the vehicle operator or driver is to be tested; and/or f) receive safety data from one or more sensors positioned in the vehicle (e.g., camera, eye scanner, fingerprint scanner, voice verification or recognition sensor, image scanner, etc.) vehicle and, in response, enable or disable operation and/or drivability of the vehicle based on whether the identity of vehicle operator or driver can be verified prior to and/or at the time the vehicle operator or driver is to be tested. This safety data can be used to a) ensure a proper testing environment of the vehicle operator or driver during testing of the vehicle operator or driver, and/or b) ensure that the vehicle operator or driver is the proper individual being tested.

Another and/or alternative object of the disclosure is the provision of impaired driving prevention system wherein the instructions stored in the memory causes the onboard operating system to display a warning to the vehicle operator or driver via the onboard interface and/or some other display based on the amount, degree or level of impairment, and/or whether one or more preconditions have or have not been met.

Another and/or alternative object of the disclosure is the provision of impaired driving prevention system wherein the instructions stored in the memory further causes the onboard operating system to (a) determine the information received from the at least one detection device is unreadable; (b) responsive to determining that the information received from the at least one detection device is unreadable, prompt the vehicle operator or driver via the onboard interface, display, mobile device, smart phone, tablet. etc. to repeat the test for the presence of the predetermined substance and/or some other physical test of the vehicle operator or driver immediately or after a predetermined amount of time; and (c) optionally subsequent to the vehicle operator or driver repeating the test, permit the vehicle operator or driver to enable operation of the vehicle if the subsequent test is not passed, contact and/or send information to emergency personnel, police, fire department, department of public safety, etc. regarding the vehicle's location when the vehicle operator or driver fails to pass the test for the presence of the predetermined substance and/or some other physical test of the vehicle operator or driver, and (d) optionally send information about the type of impairment of the vehicle operator or driver to emergency personnel, police, fire department, department of public safety, etc. regarding the vehicle's location when the vehicle operator or driver fails to pass the test for the presence of the predetermined substance and/or some other physical test of the vehicle operator or driver.

Another and/or alternative object of the disclosure is the provision of impaired driving prevention system wherein the instructions stored in the memory further causes the onboard operating system to (a) via the onboard interface, receive one or more restrictions set by an authorized user, wherein the one or more restrictions include a minimum amount, degree or level of impairment of the individual for the predetermined substance, and wherein the authorized user is a parent, guardian, court official, parole officer, vehicle owner, vehicle insurance company, mortgage company or bank or other lender that owns a mortgage or lien on vehicle, vehicle lessee, vehicle lessor, or combinations thereof; and (b) disable operation and/or drivability of the vehicle based on the one or more restrictions.

Another and/or alternative object of the disclosure is the provision of impaired driving prevention system wherein a qualified and/or authorized user can enter and/or send a passcode to the onboard interface and/or wirelessly to lock or unlock the one or more restrictions into the onboard operating system.

Another and/or alternative object of the disclosure is the provision of impaired driving prevention system that optionally further includes a storage and/or charging unit that is configured to store and/or charge at least one detection device when not in use by the vehicle operator or driver, and wherein the storage and/or charging unit is partially or fully integrated into the vehicle's steering wheel, seat, ceiling, visor, dashboard, and/or door.

Another and/or alternative object of the disclosure is the provision of impaired driving prevention system wherein the predetermined substance is an illegal drug, marijuana, alcohol, cannabidiol (cbd), tetrahydrocannabinol (THC), a stimulant, a pain medication, a depressant, a hallucinogen, a psychoactive drug or substance, an over-the-counter medication, or combinations thereof.

Another and/or alternative object of the disclosure is the provision of impaired driving prevention system wherein the instructions are installed on the memory of the onboard operating system during vehicle manufacturing and/or vehicle servicing.

Another and/or alternative object of the disclosure is the provision of impaired driving prevention system wherein at least one detection device is breathalyzer, transdermal test, eye scan tester, blood tester, blood pressure tester, body temperature tester, passive breath testing device, or combinations thereof.

Another and/or alternative object of the disclosure is the provision of impaired driving prevention system wherein the onboard interface is a touch-screen interface, and wherein the onboard interface is a portion of dashboard display, a center counsel display, an infotainment display, and/or or a heads-up display of the vehicle. The one or more displays may or may not be a touch-screen display. When one or more of the displays is a touch-screen display, the touch-screen display can be used by the vehicle operator or driver and/or some other person to operate, navigate, activate, operate control and/or display one or more features, components and/or functions of the impaired driving prevention system. The one or more touch-screen displays can be an OEM display in the vehicle or be a retrofitted display in the vehicle.

Another and/or alternative object of the disclosure is the provision of a method to inhibit or prevent impaired operation of a vehicle comprising (a) using an onboard operating system to prevent impaired operation of a vehicle, wherein the onboard operating system comprises a processor having instructions stored in a memory; (b) receiving information from at least one detection device configured to test for the presence of a predetermined substance and/or other physical attribute of an vehicle operator or driver; (c) performing an analysis of the amount of the predetermined substance and/or an analysis of the physical attribute of an vehicle operator or driver to determine an amount, degree or level of impairment of the vehicle operator or driver; (d) displaying the amount, degree or level of impairment to the individual via an onboard interface; and (e) enabling or disabling operation of the vehicle based on the amount, degree or level of impairment of the vehicle operator or driver.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for case of recognition in the drawings. Reference may now be made to the drawings, which illustrate various embodiments that the disclosure may take in physical form and in certain parts and arrangement of parts wherein:

FIG. 1 is a block diagram of a non-limiting example implementation of an impaired driving prevention system showing the basic components of the system.

FIG. 2 is a perspective view of a non-limiting exemplary impaired detection device for use with the impaired driving prevention system of FIG. 1.

FIG. 3 is a perspective view of a non-limiting storage and charging unit for the impaired detection device of FIG. 2.

FIG. 4 is a top down view of the storage and charging unit of FIG. 3.

FIG. 5 depicts the impaired driving prevention system of FIG. 1 shown in an exemplary, non-limiting vehicle.

FIG. 6 is a flow chart of a non-limiting exemplary method for using the impaired driving prevention system of FIG. 1.

FIG. 7 is a flow chart illustrating a non-limiting stepwise decision process when the impaired driving prevention system is in an unlocked (free-use) mode, in conjunction with the flow chart of FIG. 6.

FIG. 8 is a flow chart illustrating a non-limiting stepwise decision process when the impaired driving prevention system is in a locked (engaged) mode, in conjunction with the flow chart of FIG. 6.

FIG. 9 is a flow chart illustrating a non-limiting stepwise process for locking or engaging the impaired driving prevention system of FIG. 1.

FIG. 10 is a flow chart illustrating a non-limiting stepwise process for unlocking or disengaging the impaired driving prevention system of FIG. 1.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function. The singular forms “a,” “an,” and “the” include plural referents unless the context clearly dictates otherwise.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to a system and apparatus for performing the operations discussed herein. This system and apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the systems and methods described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the systems and methods described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semipermanent, and/or semitemporary.

One or more implementations of the subject application will now be described with reference to the attached figures, wherein like reference numerals are used to refer to like elements throughout.

Example implementations of the disclosed systems and methods provide an impaired driving or operating prevention system, also referred to as an vehicle interlock system, that utilize a vehicle's onboard (in-vehicle) computer and interface systems to determine and/or assist in determining whether a vehicle driver is legally and/or physically able to operate the vehicle based on detected use of alcohol and/or or other type of substance from a breathalyzer or similar impaired detection device (e.g., breath tester, transdermal tester, eye scan tester, blood tester, or combinations thereof, etc.). As appreciated, one or more of the disclosed impaired detection devices can be used in non-limiting examples to: (i) test the amount, degree, level and/or presence of intoxication of an individual, (ii) test the amount, degree, level and/or presence of illegal drugs in an individual, (iii) test the amount, degree, level and/or presence of caffeine and/or other stimulants in an individual, (iv) test the amount, degree level and/or presence of pain medication in an individual, (v) test the amount, degree, level and/or presence of depressants, relaxants and/or sleep medications in an individual, (vi) test the amount, degree, level and/or presence of psychoactive and/or hallucinogens (e.g., LSD, mescaline, psilocybin, PCP, cannabis, ecstasy, ketamine, salvia, marijuana, etc.) in an individual, and/or (vii) test the amount, degree, level and/or presence of over the counter medications in an individual. The disclosed impaired driving prevention system can advantageously be installed via software or similar programming directly into the vehicle's onboard computer system and/or vehicle's onboard interface during manufacturing of the vehicle or during vehicle servicing, allowing, for example, more wide-spread and efficient integration of impaired driving prevention systems in vehicles while avoiding the use of cumbersome components.

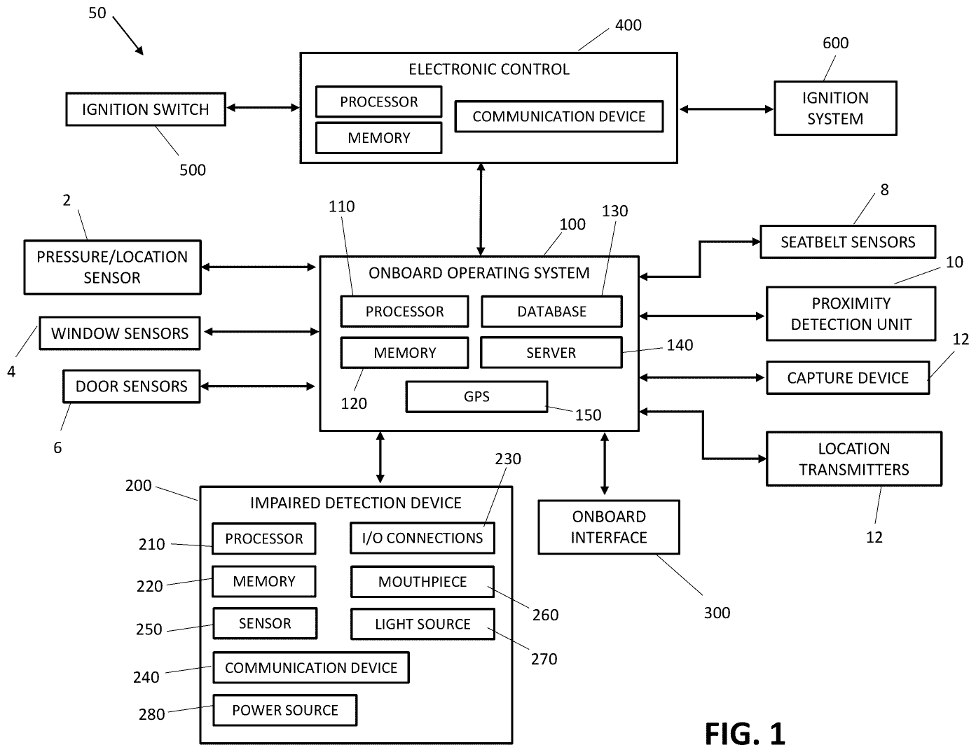

Referring now to FIG. 1, there is illustrated a block diagram of an example implementation of an impaired driving prevention system 50 that is configured to determine and/or assist in determining whether a driver is legally and/or physically able to operate a vehicle based on detected use of alcohol and/or or other type of substance(s). Although impaired driving prevention system 50 will be particularly described with reference to the detection of alcohol and/or or other type of substance(s) in a potential vehicle driver, it will be appreciated that the impaired driving prevention system 50 configured can also or alternative be configured to detect other physical attributes (e.g., dilation level of pupils, drowsiness, seizure, abnormal blood pressure, abnormal body temperature, erratic behavior, etc.) of a potential drive to determine whether is the potential driver is impaired to drive the vehicle.

The impaired driving prevention system 50 comprises an onboard operating system 100; one or more impaired detection devices 200; an onboard interface 300; and an electronic control 400 that is optionally configured to be positioned partially or fully between an ignition switch 500 and an ignition system 600. As can be appreciated, if a vehicle has one or more processors and/or displays, a portion of the impaired driving prevention system 50 can be loaded into such preexisting processors in the vehicle (e.g., download a portion or all of the software of the impaired driving prevention system 50 into the preexisting processors in the vehicle, utilized the preexisting display in the vehicle [e.g., heads-up display, display incorporated into the vehicle dashboard, etc.) to display test results, and/or to operate one or more features and/or devices of the impaired driving prevention system 50. Also, if the vehicle has GPS and/or a phone and/or emergency calling features, such features of the vehicle can be optionally utilized by the impaired driving prevention system 50. If the vehicle is absent certain devices, processing capabilities, displays, GPS or other location devices, calling devices, etc., the vehicle can be retrofitted with one or more device as required to enable the full functionality of the impaired driving prevention system 50.

The onboard operating system 100 comprises a processor 110 and a memory 120. The processor 110 can execute software instructions stored on the memory 120. In one non-limiting embodiment, the software instructions can be uploaded to the onboard operating system 100 during manufacturing of the vehicle and/or during vehicle servicing. When the processor 110 of the onboard operating system 100 executes the software instructions, the processor 110 can be caused to perform various operations and/or control various other components, features, or aspects of the impaired driving prevention system 50. It is to be appreciated that the onboard operating system 100 can include one or more processors and/or one or more memory units.

The onboard operating system 100 further includes one or more database 130 that stores and accesses data. In one non-limiting embodiment, the data stored in the database 130 can be stored in a non-volatile computer memory, such as a hard disk drive, read only memory (e.g. a ROM IC), or other types of non-volatile memory. As appreciated by those skilled in the art, a variety of other databases or other types of memory storage structures can be utilized or otherwise associated with the onboard operating system 100. The onboard operating system 100 can further include one or more servers 140 and a global positioning system (“GPS”) unit 150. The one or more servers 140 can cause data and content to be sent to the various components of the onboard operating system 100 via a network in any of a number of formats. The one or more servers 140 can be comprised of processors (e.g. CPUs), memory units (e.g. RAM, ROM), non-volatile storage systems (e.g. hard disk drive systems), and other elements.

Still referring to FIG. 1, the impaired detection device 200 comprises one or more processors 210 and one or more memory units 220 that may be configured with instructions to at least: (i) test for and measure an amount, degree, level and/or presence of an impairment substance; and (ii) transmit the data (e.g. amount, degree, level and/or presence of the substance) to the onboard operating system 100. The impaired detection device 200 further includes a set of I/O connections 230 and a communication device 240. The set of I/O connections 230 may be positioned about the exterior of the impaired detection device 200, and may include, for example, a power connector, a charging connector, a universal serial bus connector, or a proprietary connector capable of receiving data, power, or both. The communication device 240 may be one or more of a Bluetooth transceiver, Wi-Fi transceiver, cellular data transceiver, or other wireless or wired communication device capable of exchanging information with the onboard operating system 100 and/or other remote or nearby devices.

The impaired detection device 200 can further include one or more sensors 250, an optional mouthpiece 260, one or more optional light sources 270, and a power source 280. The one or more sensors 250 can be integrated into the detection device 200 and can include one or more sensor capabilities that are configured to measure data and characteristics related the detection of impairment substances. The one or more sensors 250 can be calibrated to provide accurate readings that take into account the type of impairment substance and/or the amount, degree, level required to become impaired (e.g. electrochemical sensors). As can be appreciated, other or additional types of sensors 250 (e.g., camera, blood pressure sensor, pupil dilation sensor, blood oxygen level sensor, body temperature sensor, body movement sensor, etc.). The one or more light sources 270 can be positioned about the exterior of the impaired detection device 200, and may include, for example, LEDs or other illuminators configured to provide an indication or alert that the detection device 200 is powered-ON, actively charging, and/or the charge level. The power source 280 (e.g. internal, rechargeable batteries), may be integrated into the interior of the impaired detection device 200 and positioned to connect with the set of I/O connections 230 to provide improved battery life. The one or more sensors 250 can be mounted in a stationary position in the vehicle or one or more portions of the sensor 250 can be movable by a user. When the sensor 250 includes the optional mouthpiece 260, the mouthpiece 260 can include a disposable component that is used by the user during testing and cab thereafter by disposed of for sanitary purposes.

The onboard interface 300 is communicatively coupled with the onboard operating system 100 and displays system data and information to a driver or user, and transmits driver/user inputs to the onboard operating system 100. In some embodiments, the ignition interlock setup and function described herein can be provided through an impaired driving prevention application that can be installed on the onboard interface or installed for execution by the onboard operating system 100. In some non-limiting embodiments, the onboard interface 300 is a portion of dashboard display, center counsel display, an infotainment display, or a heads-up display, for example. In some non-limiting embodiments, onboard interface 300 includes a touch-screen and/or touch-screen keyboard integrated within the display. It is to be appreciated that the onboard interface 300 can also be any smartphone, tablet, and/or wearable device with or without display capabilities (e.g. screens or similar graphical user interfaces). Because the onboard operating system 100 is integrated with the onboard interface 300 of the vehicle, it is to be appreciated that the onboard interface 300 can include a plurality of other downloadable and/or vehicle applications, including but not limited to, weather, maps and GPS guidance, music, etc.

Still referring to FIG. 1, the electronic control 400 is an onboard control system that is communicatively coupled with the onboard operating system 100, the ignition switch 500, and the ignition system 600. As can be appreciated, the electronic control 400 can be connected to other or alternative electronic devices in the vehicle that partially or fully control the operation of the vehicle. The electronic control 400 comprises one or more processors 410 and one or more memory units 420 that may be configured with instructions, in one non-limiting embodiment, to a) either prevent or allow normal ignition/start-up of the vehicle based on the information received from the onboard operating system 100 (e.g., the vehicle operator or drive has been determined to not be impaired by the impaired driving prevention system 50, etc.), or b) allow normal ignition/start-up of the vehicle, but only allow the vehicle to be driven by the vehicle operator or drive if the vehicle operator or drive has been determined to not be impaired by the impaired driving prevention system 50. As can be appreciated, the one or more memory units 420 that may be configured with other or additional instructions related to the operation and/or use of the vehicle. Communication device 430 may be one or more of a Bluetooth transceiver, Wi-Fi transceiver, cellular data transceiver, or other wireless or wired communication device capable of exchanging information with the onboard operating system 100, the ignition switch 500, the ignition system 600, other vehicle devices (e.g., vehicle CPU, vehicle fuel line control, etc.) and/or other remote or nearby devices. It is to be appreciated that the ignition switch 500 may be any button, paddle, dial, key-hole, or similar ignition input control that functions to power-ON and/or power-OFF the ignition system 600. As can be appreciated, the electronic control 400 can optionally be configured to affect other vehicle systems such as locking/unlocking the steering wheel, terminating/enabling fuel flow to the motor, terminating/enabling current to the motor, locking/unlocking emergency brake, sending instructions to the vehicle CPU to inhibit or prevent certain operations of the vehicle (e.g., driving of the vehicle, etc.), etc.

With further reference to FIG. 1, the onboard operating system 100 can optionally include any one of one or more pressure/location sensors 2 (or similar weight and/or IR sensor); one or more window sensors 4; one or more door sensors 6; one or more seatbelt or fastening sensors 8; a proximity detection unit 10; a capture device 12; and/or one or more location transmitters 14. Such components of the onboard operating system 100 aid in ensuring that the individual using the impaired detection device 200 is actually the driver or vehicle operator. In one non-limiting embodiment, if one or more of such components determine that the individual is not the proper vehicle operator, the impaired detection device 200 can be deactivated and/or one or more components of the impaired driving prevention system 50 can prevent vehicle ignition and/or otherwise prevent operation and/or driving of the vehicle. In one non-limiting embodiment, the operation and use of the impaired detection device 200 can be configured not to operate and/or transmit testing data to the onboard operating system 100 until: (a) the pressure/location sensors 2 in vehicle determined that one, live verified individual is located in the driver side seat; (b) by the one or more window sensors 4, all vehicle windows, including the driver side window, are closed; (c) by the one or more door sensors 6, all vehicle doors, including the driver side door, are closed and locked; (d) by the one or more seatbelt or fastening sensors 8, the vehicle operator's seat belt or other fastening means are buckled and/or secured, (e) only a single individual is detected in the vehicle, and/or (f) the identity of the vehicle operator or drive is verified. In another non-limiting embodiment, the operation and use of one or more features and/or functions of the onboard operating system 100 can be configured not to operate until: (a) the pressure/location sensors 2 in vehicle determined that one, live verified individual is located in the driver side seat; (b) by the one or more window sensors 4, all vehicle windows, including the driver side window, are closed; (c) by the one or more door sensors 6, all vehicle doors, including the driver side door, are closed and locked; (d) by the one or more seatbelt or fastening sensors 8, the vehicle operator's seat belt or other fastening means are buckled and/or secured, (c) only a single individual is detected in the vehicle, and/or (f) the identity of the vehicle operator or drive is verified. In another non-limiting embodiment, the operation and use of one or more features and/or functions of the impaired driving prevention system 50 can be configured not to operate until: (a) the pressure/location sensors 2 in vehicle determined that one, live verified individual is located in the driver side seat; (b) by the one or more window sensors 4, all vehicle windows, including the driver side window, are closed; (c) by the one or more door sensors 6, all vehicle doors, including the driver side door, are closed and locked; (d) by the one or more seatbelt or fastening sensors 8, the vehicle operator's seat belt or other fastening means are buckled and/or secured, (c) only a single individual is detected in the vehicle, and/or (f) the identity of the vehicle operator or drive is verified.

In one non-limiting embodiment, the proximity detection unit 10, when activated, triangulates 3-dimensional space location from a plurality of location transmitters 14 positioned within the vehicle. If the proximity detection unit 10 is not positioned in a predetermined location of the vehicle during ignition and/or use of the impaired detection device 200, the vehicle can be configured to not start and/or be driven. The capture device 12 can be one or more cameras configured to capture images and/or videos at various resolutions and framerates. In one non-limiting embodiment, the capture device 12 can be used to ensure the individual using the impaired detection device 200 is actually the driver or vehicle operator and/or monitor the individual during testing. As can be appreciated, other and/or additional devices can be used to verify the identity of the vehicle operator or driver (e.g., camera, eye scanner, fingerprint scanner, voice verification or recognition sensor, image scanner, etc.).

With further reference to FIG. 1, the disclosed impaired driving prevention system 50 utilizes the vehicle's onboard operating system 100 and onboard interface 300 to prevent ignition of the vehicle and/or otherwise prevent operation of the vehicle if the driver is illegally impaired/intoxicated or otherwise impaired based on results from the impaired detection device 200. In the present non-limiting embodiment, results from the impaired detection device 200 are transmitted to the onboard operating system 100, which may display the results to the driver via the onboard interface 300. Based on the results, the onboard operating system 100 directs the electronic control 400 to either allow or prevent ignition of the vehicle, allow or prevent operation of the vehicle, and/or allow or prevent the vehicle to be driven. The one or more pressure/location sensors 2; the one or more window sensors 4; the one or more door sensors 6; the one or more seatbelt or fastening sensors 8; the proximity detection unit 10; the capture device 12; and/or the one or more location transmitters 14 can optionally communicate with the onboard operating system 100 to further prevent or allow for vehicle ignition and/or operation of the vehicle via the electronic control 400.

In certain embodiments, the impaired driving prevention system 50 can be configured for use in a locked (engaged) mode or in an unlocked (free-use) mode. In certain embodiments of the unlocked mode, the vehicle user may optionally provide a breath/substance sample or other physical attributes of the vehicle user to the detection device 200 without any restrictions, regardless of the detected result. In certain embodiments of the locked mode, the vehicle user may be restricted from using the vehicle depending on the detected results from the detection device 200. In certain embodiments, the locked mode may require the vehicle user to provide a breath sample and/or allow testing of other physical attributes of the vehicle operator to the detection device 200 that meets certain conditions before allowing operation of the vehicle. The impaired driving prevention system 50 can be placed into the unlocked mode by an authorized user, e.g., parent, court official, etc., opening the interlocking application and/or program and selecting the appropriate prompts to unlock. In certain embodiments, the authorized user can be required to enter the passcode to unlock the impaired driving prevention system 50. Generally, the authorized user is not the vehicle operator.

The onboard operating system 100 can optionally include a receiver/transmitter (not shown) that can be used to transmit and/or receive information form a remote location (e.g., cloud, cell tower, Bluetooth device, smart phone, tablet, smart device, computer, server, etc.). Such receiver/transmitter can be used to a) update software of one or more components of the impaired driving prevention system 50, b) update and/or change parameters of one or more components of the impaired driving prevention system 50, c) transmit information about the vehicle (e.g., vehicle location information, vehicle speed, location of driver in vehicle, information about passengers in the vehicle, does driver have one or two hands on steering wheel, is driver seatbelt locked, path of travel of vehicle, is vehicle being maintained in a lane, has vehicle illegally run stop signs or red lights, does vehicle have lights on at night, are turning signals being properly used, is proper speed of vehicle being maintained, etc.) and/or test results to a remote location (e.g., public safety agency, police, hospital, fire department, ambulance service, towing service, parent, guardian, court official, parole officer, vehicle owner, vehicle insurance company, mortgage company or bank or other lender that owns a mortgage or lien on vehicle, vehicle lessee, vehicle lessor, etc.), and/or d) receive information (e.g., passcode, system reset, system unlock codes, system lock codes, instructions to terminate operation of vehicle, instructions to allow operation of vehicle, etc.) from a remote location.

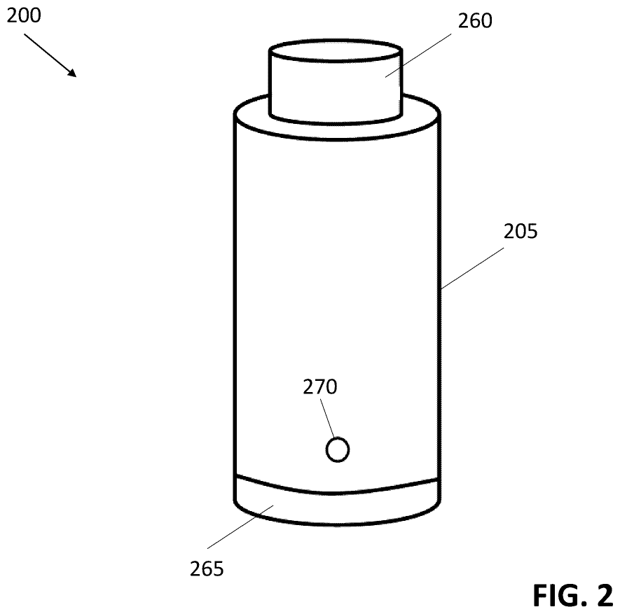

Referring now to FIG. 2, there is illustrated a perspective view of a non-limiting exemplary impaired detection device 200 for use with the impaired driving prevention system 50. In the present non-limiting embodiment, the impaired detection device 200 is a wireless breathalyzer; however, it is to be appreciated that the impaired detection device 200 could be a transdermal tester, an eye scan tester, a blood tester, blood pressure tester, blood oxygen tester, or similar wire or wireless impaired detection device based on the desired impaired substance and/or physical attribute to be tested. With reference to FIGS. 1-2, the mouthpiece 260 is coupled to a body 205 of the detection device 200. The one or more light sources 270 is optionally positioned about the exterior of the body 205. The impaired detection device 200 can optionally include a conductive portion 265 (e.g. metallic portion-silver, gold, copper, steel, etc.) positioned about at least a portion of the exterior of the body 205 that is configured to charge/recharge the power source 280; however, it is to be appreciated that the set of I/O connections 230 could alternatively be used to, for example, charge/recharge the power source 280.

Again with reference to FIG. 2, the present exemplary impaired detection device 200 can optionally be configured to be smaller and more compact than conventional breathalyzers, thereby allowing the detection device 200 to be more easily and more discreetly stored within the vehicle, for example. In the present non-limiting embodiment, impaired detection device 200: (i) can optionally be free of screens, displays, or similar graphical user interfaces; and (ii) can optionally be free of buttons, switches, paddles, dials, scroll wheels, or the like. In various non-limiting embodiments, the detection device 200 can be a handheld device and/or be partially or fully integrated into one or more components of the vehicle (e.g., steering wheel, visor, ceiling, dashboard, door, etc.).

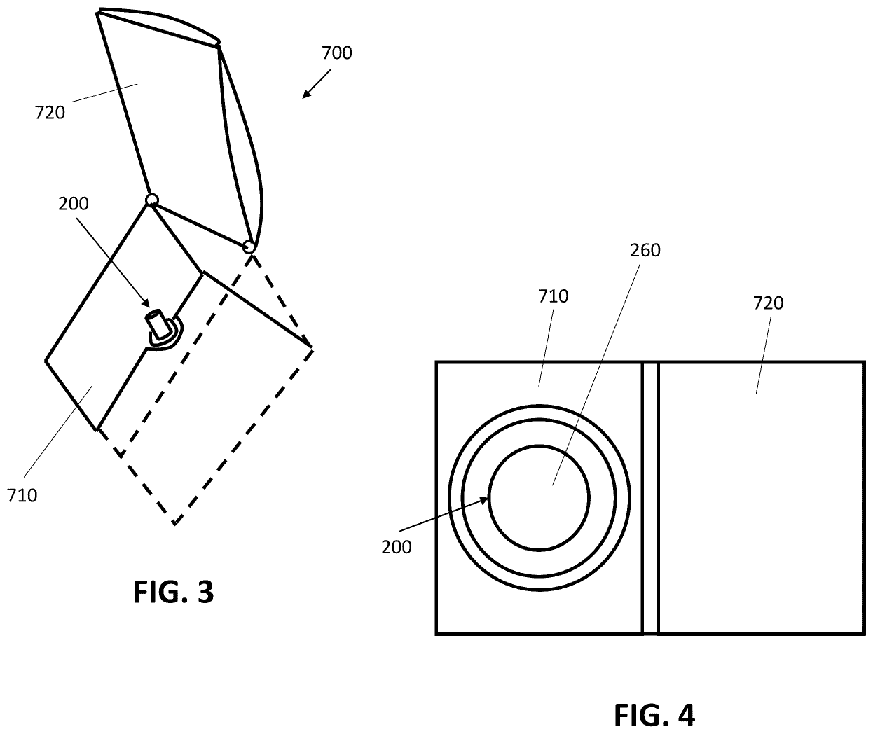

Referring now to FIG. 3, there is illustrated a perspective view of a non-limiting storage and charging unit 700 configured for the impaired detection device 200. FIG. 4 is a top down view of the storage and charging unit 700. With reference to FIGS. 2-4, storage and charging unit 700 can include a receptacle 710 and a cover 720. The receptacle 710 can be configured to receive and charge the impaired detection device 200 while not in use. In various non-limiting embodiments, the storage and charging unit 700 can be partially or fully integrated into one or more components of the vehicle (e.g., steering wheel, visor, dashboard, ceiling, seat, door, etc.) to discretely and easily store and charge the impaired detection device 200. In one non-limiting embodiment, the impaired detection device 200 can optionally utilize an existing in-vehicle lighter to store, charge, and/or recharge the detection device 200.

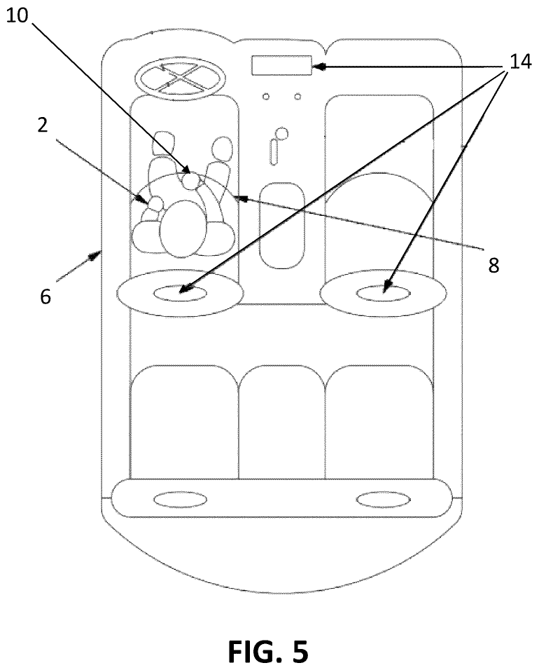

Referring now to FIG. 5, there is illustrated the non-limiting exemplary placement of the one or more pressure/location sensors 2, the one or more window sensors 4, the one or more door sensors 6, the one or more seatbelt or fastening sensors 8, the one or more proximity detection units 10, and/or the one or more location transmitters 14 within a non-limiting vehicle 20. The one or more pressure/location sensors 2, the one or more window sensors 4, the one or more door sensors 6, the one or more seatbelt or fastening sensors 8, the one or more proximity detection units 10, and the one or more location transmitters 14 are configured to each communicate with the onboard operating system 100 to ensure that the individual using the impaired detection device 200 is actually the driver or vehicle operator. As can be appreciated, all or some subset of the above listed sensors can be used in the vehicle. For non-limiting example, the vehicle can only include one or more pressure/location sensors 2. In another non-limiting example, the vehicle can only include one or more pressure/location sensors 2 and one or more proximity detection units 10. Other sensors or combination of sensors can also be used in the vehicle. Although the sensor arrangement illustrated in FIG. 5 is used to determine if the driver or vehicle operator is in the proper location in the vehicle and is the individual being tested, it can be appreciated that one or more of the sensors can be used to determine if other individuals or animals are located in the vehicle. The impaired driving prevention system 50 can optionally be configured to prevent operation of the impaired detection device 200 if one or more other individuals and/or animals are located in the vehicle at the time that the driver or vehicle operator is to use the impaired detection device 200. As can be appreciated, one or more of the sensors and/or other components of the impaired driving prevention system 50 can be OEM components of the vehicle and/or one or more sensors or components of the impaired driving prevention system 50 can be added or retrofitted in the vehicle as needed.

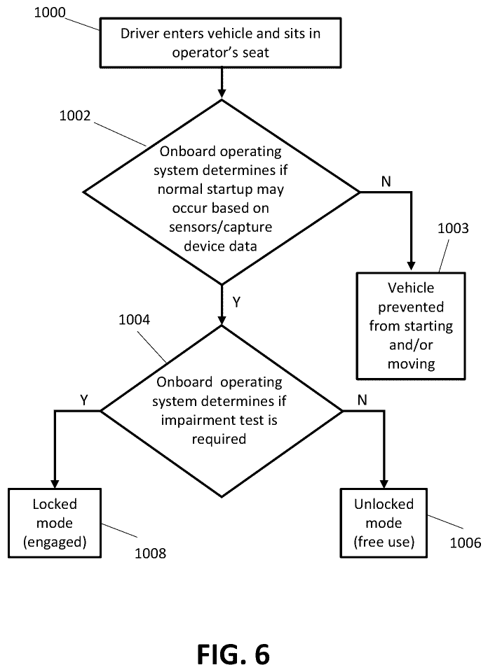

Referring now to FIG. 6, there is illustrated a flow chart of a non-limiting example of a method or process for using an example implementation of the disclosed impaired driving prevention system. In FIG. 6, the method starts at step 1000 with the driver or vehicle operator entering the vehicle and sitting in the operator's seat, in proximity to the impaired driving prevention system; the onboard operating system determines if normal startup of the vehicle may occur at decision point 1002 based on data received from the one or more: (i) pressure/location sensors; (ii) window sensors; (iii) door sensors; (iv) seatbelt or fastening sensors; (v) proximity detection units; and/or (vi) capture devices. If the data does not comply with the requirements of the onboard operating system, the vehicle is disabled and prevented from starting and/or being able to be moved or driven at step 1003. If the data does comply with the requirements of the onboard operating system, the onboard operating system next optionally determines if an impairment test is required/mandatory at decision point 1004. If an impairment test is not required, the impaired driving prevention system enters unlocked (free use) mode at step 1006. If an impairment test is required, the impaired driving prevention system enters a locked (engaged) mode at step 1008. As can be appreciated, the impairment test can be always be made mandatory.

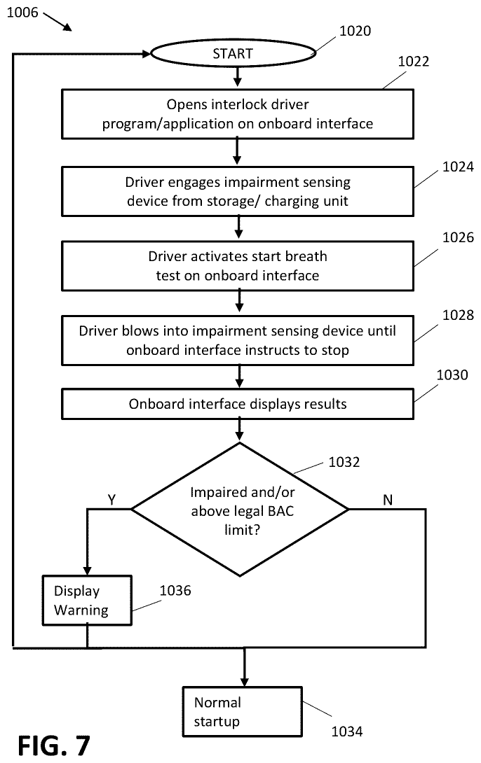

Referring now to FIG. 7, there is illustrated a flow chart of a non-limiting stepwise decision process when the impaired driving prevention system is in the unlocked (free-use) mode of step 1006. As illustrated in FIG. 7, the method starts at step 1020. The driver opens an impaired driving prevention application/program on the onboard interface at step 1022. The driver engages (e.g., removes, engages with, etc.) the impairment sensing device from a storage and/or charging unit at step 1024. The driver activates the onboard interface at step 1026 to start the breath test or some other test. The driver blows into the impairment sensing device, if a breath test, and/or performs some other activity for other types of tests until the onboard interface instructions the driver to stop at step 1028. At step 1030, the onboard interface displays the results of the breath test and/or other type test to the driver (e.g., displays BAC reading or other amount, degree and/or level of impairment). Based on the results of the breath test and/or other type of test, the onboard operating system then determines if the driver is impaired and/or above the legal BAC limit, and/or above or below some other limit for some other type of test at decision point 1032. If the driver is not impaired and/or not above the legal BAC limit, and/or above and/or below some other limit for some other type of test, the onboard operating system communicates with the electronic control to allow for normal vehicle startup at step 1034. If the driver is impaired and/or above the legal BAC limit, and/or above or below some other limit for some other type of test, the onboard operating system displays a warning message to the driver via the onboard interface at step 1036. The driver may then optionally decide whether to proceed to normal vehicle startup at step 1034 or return to step 1006 and retest until the driver is no longer impaired and/or above the legal BAC limit, and/or above or below some other limit for some other type of test. One modification to the method illustrated in FIG. 7 is that if the driver is impaired and/or above the legal BAC limit, and/or above or below some other limit for some other type of test, the onboard operating system displays a warning message to the driver via the onboard interface at step 1036, and the driver only has the option to return to step 1006 and retest until the driver is no longer impaired and/or above the legal BAC limit, and/or above or below some other limit for some other type of test, or not drive the vehicle. The impaired driving prevention system 50 can optionally be configured to enter into locked (engaged) mode of step 1008 of FIG. 6, if not already in locked (engaged) mode, if the driver is impaired and/or above the legal BAC limit, and/or above or below some other limit for some other type of test.

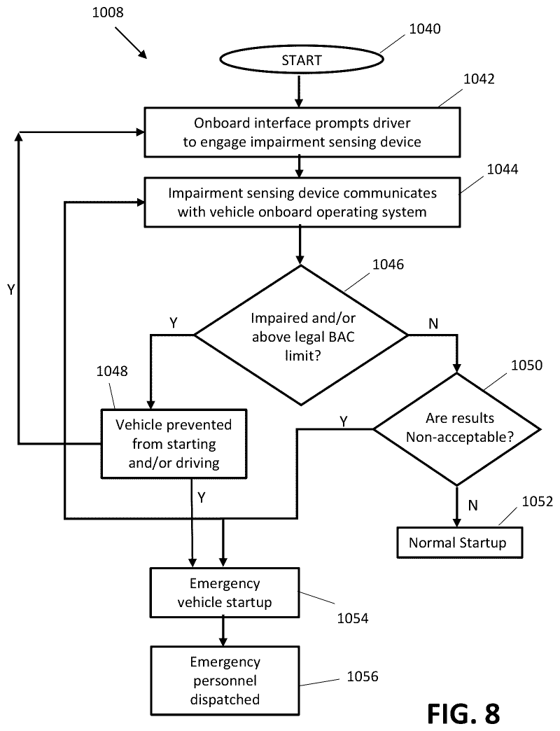

FIG. 8 is a flow chart illustrating a non-limiting stepwise decision process when the impaired driving prevention system is in the locked (engaged) mode of step 1008. In FIG. 8, the method starts at step 1040. The onboard interface prompts the driver to engage the impairment sensing device at step 1042. At step 1044, the impairment sensing device receives a breath test and/or some other test from the driver and communicates the results with the onboard operating system. The onboard operating system determines if the driver is impaired and/or above the legal BAC limit, and/or above or below some other limit for some other type of test at decision point 1046. If the driver is impaired and/or above the legal BAC limit, and/or above or below some other limit for some other type of test, the vehicle is locked or prevented from starting and/or driving at step 1048. If the driver is not impaired and/or not above the legal BAC limit, and/or above or below some other limit for some other type of test, the onboard operating system determines if the results are non-acceptable (e.g. unreadable) or invalid at decision point 1050. If the results are acceptable/valid, the vehicle proceeds to normal start up at step 1052. If the results are non-acceptable/invalid, the onboard operating system allows the user at least one additional opportunity to repeat the breath test from step 1044 immediately or after a predetermined amount of time. If the onboard operating system again determines that the results are non-acceptable/invalid at decision point 1050, the driver may optionally enable emergency vehicle startup at step 1054, or be prevented to operate and/or drive the vehicle. If emergency vehicle startup at step 1054 is an available option in the impaired driving prevention system 50, the impaired driving prevention system 50 can be configured to automatically contact emergency personal to be dispatched to the vehicle based on the vehicle's GPS system at step 1056 so that a) the vehicle can be moved to an authorized location (e.g., police lot, driver home, etc.), b) the driver can be taken home, taken to medical facility, taken to a police station, etc.). Also, if emergency vehicle startup at step 1054 is an available option in the impaired driving prevention system 50, the impaired driving prevention system 50 can also or alternatively be configured to automatically contact a designated or authorized person (e.g., parent, relative, spouse, partner, friend, minister, priest, social worker, psychologist, psychiatrist, co-worker, etc.). As illustrated in FIG. 8, after step 1048, the impaired driving prevention system 50 can be configured can be configured to a) enter emergency vehicle startup at step 1054, if an available feature, and/or b) have the onboard interface prompt the driver to engage the impairment sensing device at step 1042 for retesting. The step of retesting can be limited to a certain number or times and/or be required within a certain timer period.

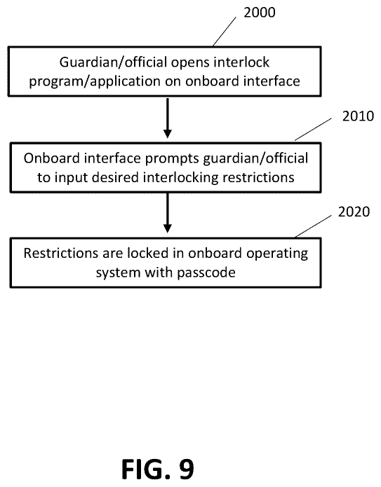

Referring now to FIG. 9, there is illustrated a flow chart for a non-limiting stepwise process for a public safety agency, police, hospital, fire department, ambulance service, towing service, parent, guardian, court official, parole officer, vehicle owner, vehicle insurance company, mortgage company or bank or other lender that owns a mortgage or lien on vehicle, vehicle lessee, vehicle lessor, etc. to lock or engage the impaired driving prevention system 50. The method begins at step 2000 when the guardian/official, etc. opens the impaired driving prevention application/program on the onboard interface. The onboard interface prompts the guardian/official, etc. to input the desired interlocking restrictions (e.g. minimum BAC level, legal BAC operating level, minimum impairment substance levels, etc.) at step 2010. The desired restrictions are locked into the onboard operating system with a guardian/official, etc.—set passcode at step 2020. It is to be appreciated that the onboard interface can be configured to include a display a touch-screen keyboard, keypad, or similar input controls for entry of the restrictions and/or passcode. As can be appreciated, the impaired driving prevention system 50 can optionally be configured to enable remote entry of the restrictions and/or passcode (e.g., remove entry via the cloud, cell tower, smart device, smart phone, etc.).

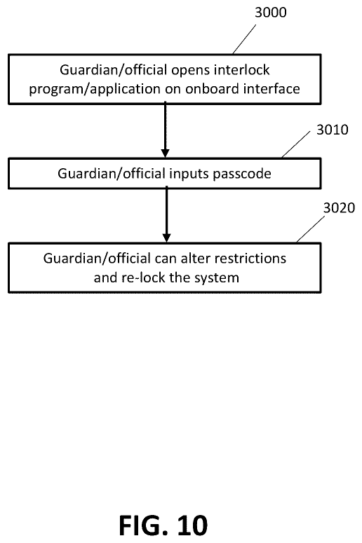

Referring now to FIG. 10, there is illustrated a flow chart for a non-limiting stepwise process for a parent, guardian, court official, etc. to unlock, edit, and relock the interlock restrictions of the impaired driving prevention system. The method begins at step 3000 when the guardian/official, etc. opens the impaired driving prevention application/program on the onboard interface. The guardian/official, etc. then inputs the guardian/official, etc.—set passcode into the onboard interface at step 3010. At step 3020, the guardian/official, etc. can edit the desired interlocking restrictions and relock the edited restrictions with the same and/or different guardian/official-set passcode.

It will be appreciated that any of a variety of additional or alternative steps may be included in a method of using the impaired driving prevention system 50.

In certain non-limiting embodiments, the impaired driving prevention system 50 can include one or more sensors to detect substances in the air in the vehicle (e.g., alcohol, smoke, substance levels, etc.). Such sensors, upon detecting a certain substance level in the air can cause the vehicle to be deactivated and thereafter require the operator of the vehicle to conduct a first or another test using the impaired detection device 200. In other non-limiting embodiments, the vehicle can become deactivated if any of the sensors disclosed herein determine that the tested individual is no longer operating the vehicle (e.g., individual moved to another seat after the vehicle was started, someone other than the individual in the driver seat is steering or otherwise operating the vehicle, etc.).

In certain non-limiting embodiments, the impaired driving prevention system 50 can utilize in-vehicle speakers or similar in-vehicle audio components to provide an audible alert, tone, or other indicator, such as a machine simulated voice or sound, if the driver is impaired and/or above the legal BAC limit, and/or above or below some of test limit.

A primary advantage of the disclosed system is that it utilizes the vehicle's onboard operating systems to prevent ignition and/or operation of the vehicle if the driver is illegally impaired/intoxicated or otherwise impaired, allowing for more wide-spread and efficient integration of impaired driving prevention systems in new and existing vehicles. Other advantages of the disclosed system include the following: (i) the system utilizes a compact impaired detection device that is discreet and easily concealable; (ii) the system stores test/data information and results in the memory and/or database of the onboard operating system; (iii) the system uses GPS technology already configured within the vehicle; and/or (iv) the system uses the in-vehicle, onboard interface to interact with drivers, passengers, and other users.

A computer system in accordance with the present disclosure can be accessed via any suitable technique, such as a web-browser. In some embodiments, the systems and methods described herein can be a web-based application or a stand-alone executable. Additionally, in some embodiments, the systems and methods described herein can integrate with other systems of various types. Any suitable device can be used to access, or execute, one or more portions of the systems for warning a vehicle operator, such as laptop computers, desktop computers, smart phones, tablet computers, and the like.

Interaction with the detection system and/or the receiving device can be possible and may include, without limitation, keyboard entry, writing from pen, stylus, finger, or the like, with a computer mouse, or other forms of input (voice recognition, etc.). A user, e.g., vehicle operator or passenger, may receive real-time feedback, or at least near real-time feedback, or may synchronize with the detection system and/or the receiving device at a later date.

The description of embodiments and examples has been presented for purposes of illustration and description. It is not intended to be exhaustive or limiting to the forms described. Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. An impaired driving prevention system, comprising:
(a) an onboard operating system comprising instructions stored in a memory, which when executed by one or more processors causes said onboard operating system of a vehicle to:
(i) receiving information from at least one detection device is configured to test for an impairment event or impairment activity;
(ii) performing an analysis said information from said at least one detection device to determine if an impairment exists for a vehicle driver or operator;
(iii) displaying an amount, degree or level of impairment and/or a type of impairment of the vehicle driver or operator via an onboard interface when said impairment exists; and
(iv) enabling or disabling operation of the vehicle based on said amount, degree or level of impairment and/or the type of impairment of the vehicle driver or operator and/or whether said impairment exists; and
wherein said onboard operating system includes a verification arrangement to a) ensure a proper testing environment of the vehicle driver or operator during use of said at least one detection device by the vehicle driver or operator, and/or b) ensure that the vehicle driver or operator is the proper individual being tested during use of said at least one detection device.

2. The impaired driving prevention system as defined in claim 1, wherein said step of receiving information from said at least one detection device includes determining a presence of a predetermined substance in the vehicle driver or operator, and wherein said information includes an amount of said predetermined substance, and wherein said step of performing an analysis includes determining an amount of said predetermined substance in the vehicle driver or operator to determine said amount, degree or level of impairment of the vehicle driver or operator.

3. The impaired driving prevention system as defined in claim 1, wherein said instructions stored in said memory further causes said onboard operating system to determine whether the vehicle driver or operator is required to use said at least one detection device so as to determine said amount, degree or level of impairment of the vehicle driver or operator prior to the vehicle driver or operator being able to operate and/or drive the vehicle.

4. The impaired driving prevention system as defined in claim 1, wherein said verification arrangement causes said onboard operating system to:
(a) receive safety data of the vehicle driver or operator from one or more location sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle driver or operator is located in an operating seat of the vehicle;
(b) receive safety data from one or more window sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle's windows are closed;
(c) receive safety data from one or more door sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle's doors are locked;
(d) receive safety data from one or more seatbelt sensors and/or seat sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle operator or driver is properly seated in a seat and/or the seat belt is fastened, and/or whether the detected weight on said seat matches or closely matches a weight of the vehicle operator or driver so as to verify that only one person is on said seat and/or the vehicle operator or driver is on the seat;
(e) receive safety data from one or more sensors positioned in the vehicle and, in response, enable or disable operation and/or drivability of the vehicle, enable or disable use of said at least one detection device test by the vehicle driver or operator, and/or enable or disable a drivability of the vehicle based on whether there are individuals and/or animals in the vehicle other than the vehicle driver or operator prior to and/or at a time the vehicle driver or operator to be tested during said step of perform an analysis of to determine if an impairment exist for a vehicle driver or operator; and/or
(f) receive safety data from one or more sensors positioned in the vehicle and, in response, enable or disable operation and/or drivability of the vehicle, enable or disable use of said at least one detection device test by the vehicle driver or operator, and/or enable or disable a drivability of the vehicle based on whether an identity of the vehicle operator or driver can be verified prior to and/or at a time the vehicle driver or operator to be tested during said step of perform an analysis of to determine if an impairment exist for a vehicle driver or operator.

5. The impaired driving prevention system as defined in claim 1, wherein said instructions stored in said memory further causes said onboard operating system to display a warning to the vehicle driver or operator via said onboard interface based on said amount, degree or level of impairment.

6. The impaired driving prevention system as defined in claim 1, wherein said instructions stored in said memory further causes said onboard operating system to:
(a) determine said information received from said at least one detection device is unreadable; and
(b) responsive to determining that said information received from said at least one detection device is unreadable, prompt the vehicle driver or operator via said onboard interface to repeat said test immediately or after a predetermined amount of time.

7. The impaired driving prevention system as defined in claim 6, wherein said instructions stored in said memory further causes said onboard operating system to:
(c) subsequent to the vehicle driver or operator repeating said test, permit the vehicle driver or operator to dispatch emergency personnel and/or an authorized person to the vehicle based on GPS data stored in said onboard operating system.

8. The impaired driving prevention system as defined in claim 1, wherein said instructions stored in said memory further causes said onboard operating system to:
(a) via said onboard interface, receive one or more restrictions set by an authorized user, wherein said one or more restrictions include a minimum amount, degree or level of impairment of the vehicle driver or operator, and wherein said authorized user is a parent, guardian, court official, parole officer, or combinations thereof; and
(b) disable operation of the vehicle and/or disable drivability of the vehicle based on said one or more restrictions.

9. The impaired driving prevention system as defined in claim 8, wherein said authorized user can enter a passcode through said onboard interface and/or via a wireless interface to lock or unlock said one or more restrictions in said onboard operating system.

10. The impaired driving prevention system as defined in claim 1, further comprising a storage and charging unit configured to store and charge said at least one detection device when not in use by the vehicle driver or operator, and wherein said storage and charging unit is partially or fully integrated into the vehicle's steering wheel, seat, visor, ceiling, dashboard, or door.

11. The impaired driving prevention system as defined in claim 1, wherein said at least one detection device is configured to test for a predetermined substance; said predetermined substance includes an illegal drug, marihuana, alcohol, cannabidiol (cbd), tetrahydrocannabinol (THC), a stimulant, a pain medication, a depressant, a hallucinogen, a psychoactive drug or substance, an over-the-counter medication, or combinations thereof.

12. The impaired driving prevention system as defined in claim 1, wherein said instructions are installed on said memory of said onboard operating system during vehicle manufacturing and/or vehicle servicing.

13. The impaired driving prevention system as defined in claim 1, wherein said at least one detection device is a breathalyzer, transdermal test, eye scan tester, blood tester, blood pressure tester, body temperature tester, passive breath testing device, or combinations thereof.

14. The impaired driving prevention system as defined in claim 1, wherein said onboard interface includes a touch-screen interface, and wherein said onboard interface is at least a portion of dashboard display of the vehicle, at least a portion of a center counsel display of the vehicle, at least a portion of an infotainment display of the vehicle, and/or at least a portion of a heads-up display of the vehicle.

15. A method, comprising:
(a) using an onboard operating system to prevent impaired operation of a vehicle, wherein said onboard operating system includes a processor that includes instructions stored in a memory;
(b) by said processor, receiving information from at least one detection device configured to test for the presence of a predetermined substance in a vehicle driver or operator, wherein said information comprises an amount of said predetermined substance;
(c) by the processor, performing an analysis of said amount of said predetermined substance to determine an amount degree or level of impairment of the vehicle driver or operator;
(d) by the processor, displaying said amount, degree or level of impairment to the vehicle driver or operator via an onboard interface;
(e) by the processor, enabling or disabling operation and/or drivability of the vehicle based on said amount, degree or level of impairment of the vehicle driver or operator; and
(f) ensuring a proper testing environment of the vehicle driver or operator during use of said at least one detection device by the vehicle driver or operator, and/or ensuring that the vehicle driver or operator is the proper individual being tested during use of said at least one detection device.

16. The method as defined in claim 15, wherein said step of ensuring includes, by said processor:
(a) receiving safety data of the vehicle driver or operator from one or more location sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle driver or operator is located in an operating seat of the vehicle;
(b) receiving safety data from one or more window sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle's windows are closed;
(c) receiving safety data from one or more door sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle's doors are locked;
(d) receiving safety data from one or more seatbelt sensors and/or seat sensors positioned in the vehicle and, in response, enable or disable operation and/or drivability of the vehicle, enable or disable use of said at least one detection device test by the vehicle driver or operator, and/or enable or disable a drivability of the vehicle based on whether the vehicle operator or driver is properly seated in a seat and/or the seat belt is fastened, and/or whether the detected weight on said seat matches or closely matches a weight of the vehicle operator or driver so as to verify that only one person is on said seat and/or the vehicle operator or driver is on the seat;
(e) receiving safety data from one or more sensors positioned in the vehicle and, in response, enable or disable operation and/or drivability of the vehicle, enable or disable use of said at least one detection device test by the vehicle driver or operator, and/or enable or disable a drivability of the vehicle based on whether there are individuals and/or animals in the vehicle other than the vehicle driver or operator prior to and/or at a time the vehicle driver or operator to be tested during said step of perform an analysis of to determine if an impairment exist for a vehicle driver or operator; and/or
(f) receiving safety data from one or more sensors positioned in the vehicle and, in response, enable or disable operation and/or drivability of the vehicle, enable or disable use of said at least one detection device test by the vehicle driver or operator, and/or enable or disable a drivability of the vehicle based on whether an identity of the vehicle operator or driver can be verified prior to and/or at a time the vehicle driver or operator to be tested during said step of perform an analysis of to determine if an impairment exist for a vehicle driver or operator.

17. The method of as defined in claim 15, further comprising, by the processor:
(a) determining said information received from said at least one detection device is unreadable; and
(b) responsive to determining that said information received from said at least one detection device is unreadable, prompting the vehicle driver or operator via the onboard interface to repeat said test for said presence of said predetermined substance immediately or after a predetermined amount of time.

18. The method as defined in claim 17, further includes the step of:
(c) subsequent to the vehicle driver or operator repeating said test, permit the vehicle driver or operator to dispatch emergency personnel and/or an authorized person to the vehicle based on GPS data stored in said onboard operating system.

19. The method of as defined in claim 15, further comprising, by said processor:
(a) receiving one or more restrictions from said onboard interface set by an authorized user, wherein said one or more restrictions include a minimum amount, degree or level of impairment of the vehicle driver or operator for said predetermined substance, and wherein said authorized user is a parent, guardian, court official, parole officer, or combinations thereof; and
(b) disabling operation and/or drivability of the vehicle based on the one or more restrictions.

20. The method as defined in claim 19, further comprising, by said authorized user, entering a passcode through said onboard interface to lock or unlock said one or more restrictions in said onboard operating system.
